(19) United States
(12) Patent Application Publication
(10) Pub. No.: US 2005/0017197 A1
(43) Pub. Date: Jan. 27, 2005

(54) Scanning microscope and method for scanning microscopy

(75) Inventors: Heinrich Ulrich, Heidelberg (DE); Werner Knebel, Kronau (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Heidelberg GmbH, Mannheim (DE)

(21) Appl. No.: 10/898,770

(22) Filed: Jul. 26, 2004

(30) Foreign Application Priority Data
Jul. 26, 2003 (DE) DE 103 34 146.3
Jun. 21, 2004 (DE) DE102004029733.9

(51) Int. Cl. G01N 21/64

(52) U.S. Cl. 250/458.1

(57) ABSTRACT

A scanning microscope has a detector for detecting the detected light proceeding from a sample. A bandpass filter, containing a combination of a short-pass filter and at least one long-pass filter, is arranged in the light path of the detected light. The detector is a non-descan detector.

### CROSS REFERENCE TO RELATED APPLICATIONS

This application claims priority to German patent application 103 34 146.3 and to German patent application 10 2004 029 733.9, the subject matter of each of which is hereby incorporated by reference herein.

### FIELD OF THE INVENTION

The invention concerns a scanning microscope. The invention further concerns a method for scanning microscope on a sample.

### BACKGROUND OF THE INVENTION

In scanning microscopy, a sample is illuminated with a light beam in order to observe the detected light emitted, as reflected or fluorescent light, from the sample. The focus of an illuminating light beam is moved in a sample plane by means of a controllable beam deflection device, generally by tilting two mirrors, the deflection axes usually being perpendicular to one another so that one mirror deflects in the X direction and the other in the Y direction. Tilting of the mirrors is brought about, for example, by means of galvanometer positioning elements. The power level of the detected light coming from the specimen is measured as a function of the position of the scanning beam. The positioning elements are usually equipped with sensors to ascertain the present mirror position. In confocal scanning microscopy specifically, a specimen is scanned in three dimensions with the focus of a light beam.

A confocal scanning microscope generally comprises a light source, a focusing optical system with which the light of the source is focused onto an aperture (called the “excitation pinhole”), a beam splitter, a beam deflection device for beam control, a microscope optical system, a detection pinhole, and the detectors for detecting the detected or fluorescent light. The illuminating light is coupled in via a beam splitter. The fluorescent or reflected light coming from the specimen travels back via the beam deflection device to the beam splitter, passes through it, and is then focused onto the detection pinhole behind which the detectors are located. This detection configuration is called a descan configuration. Detected light that does not derive directly from the focus region takes a different light path and does not pass through the detection pinhole, so that a point datum is obtained which results, by sequential scanning of the specimen with the focus of the illuminating light beam, in a three-dimensional image. A three-dimensional image is usually achieved by acquiring image data in layers. Commercial scanning microscopes usually comprise a scanning module that is flange-mounted onto the stand of a conventional light microscope, the scanning module containing all the aforesaid elements additionally necessary for scanning a sample.

German Unexamined Application DE 198 35 070 A1 discloses an arrangement for adjustable wavelength-dependent detection in a laser scanning microscope. The arrangement comprises a combination, arranged in the detection beam path of the laser scanning microscope, of a short-pass and a long-pass filter that together constitute an adjustable bandpass filter.

In confocal scanning microscopy, in the case of two-photon (or multi-photon) excitation it is possible to dispense with a detection pinhole, since the excitation probability depends on the square of the photon density and therefore on the square of the illumination intensity, which of course is much greater at the focus than in neighboring regions. The fluorescent light to be detected therefore very probably derives almost entirely from the focus region, thus rendering superfluous any further differentiation, using a pinhole arrangement, between fluorescence photons from the focus region and fluorescence photons from the neighboring regions.

The scientific publication of G. Gauderon, P. B. Lukins, and C. J. R. Sheppard, “Three-dimensional second-harmonic generation imaging with femtosecond laser pulses,” Opt. Lett. 23, pp. 1209-1211, 1998, discloses an incident-light scanning microscope based on the nonlinear phenomenon of second-harmonic generation (SHG). SHG is a process in which a phase adaptation condition must be met. The wavelength of the detected light corresponds to exactly half the wavelength of the illumination light beam with whose focus the sample is scanned. With this scanning microscope, in order to increase the quantity of detected light arriving at the detector, the sample is mounted on a mirror that reflects the detected light emitted in the backward direction (opposite to the propagation direction of the illuminating light beam), so that this light is conveyable to the detector together with the detected light emitted in the backward direction (opposite to the propagation direction of the illuminating light beam).

A non-descan configuration, in which the detected light does not travel to the detector via the beam deflection device (descan arrangement) and the beam splitter for coupling in the illuminating light, but instead is deflected out and detected, for example, directly after the objective using a dichroic beam splitter, is of interest especially in view of an already low fluorescence photon yield in the context of two-photon excitation or second-harmonic generation, since less light is generally lost on this detected light path. In addition, scattered components of the detected light contribute significantly to the signal in the case of two-photon excitation with descan detection; this plays only a substantially reduced role in the context of non-descan detection. Configurations of this kind are known, for example, from the publication of David W. Piston et al., “Two-photon-excitation fluorescence imaging of three-dimensional calcium ion activity,” Applied Optics, Vol. 33, No. 4, February 1996, and from Piston et al. “Time-Resolved Fluorescence Imaging and Background Rejection by Two-Photon Excitation in Laser Scanning Microscopy,” SPIE Vol. 1640.

U.S. Pat. No. 6,169,289 B1 discloses a microscope with multi-photon excitation in which the detected light proceeding from the sample is detected, in non-descan detection, on the condenser side.

Scanning microscopes with non-descan detection have the disadvantage that unlike the situation with descan detectors, the detected light beam to be detected is not stationary at the location of the detector. The result of this is that multi-band detectors, such as those known e.g. from German Unexamined Application DE 198 03 151 A1, cannot be used. The electrical beam splitters for splitting the detected light into multiple detection channels on the one hand are not variably adjustable, and as a rule result in spectrally very broad detection channels that, in particular, do not permit a differentiation between SHG light and autofluorescence light.

### SUMMARY OF THE INVENTION

It is therefore an object of the present invention to provide a scanning microscope that makes possible spectrally high-precision investigation of a sample with non-descan detection.

The present invention provides a scanning microscope comprising: a non-descan detector for detecting the detected light proceeding from a sample, a bandpass filter, which comprises a combination of at least one short-pass filter and at least one long-pass filter and which is arranged in the light path of the detected light.

A further object of the invention is to provide a method for the investigation of a sample whose detected light is based on generation of a harmonic, while largely eliminating interfering and distorting components in the detected light.

The present invention also provides a method including the following steps:

ascertaining an illuminating light frequency at which detected light having the frequency of a harmonic of the illuminating light frequency can be generated in the sample;

illuminating the sample with illuminating light of the ascertained illuminating light frequency;

blocking out from the detected light proceeding from the sample those light components that have the frequency of the illuminating light and/or the frequency of autofluorescence light, using a bandpass filter that comprises a combination of a short-pass and at least one long-pass filter and is arranged in the light path of the detected light; and

detecting the filtered detected light using a non-descan detector.

The invention has the advantage, in particular for the detection of detected light based on second-harmonic generation, that the bandpass filter on the one hand can be adjusted quite accurately to the second-harmonic wavelength, and moreover that the separation resolution is sufficient to simultaneously block the autofluorescence light out of the detected light.

In a particular embodiment of the scanning microscope, the short-pass filter and/or the long-pass filter is a spectral gradient filter that preferably is embodied as a dielectric filter.

The short-pass and long-pass filters are displaceable transversely to the propagation direction of the detected light, so that the lower and upper limits of the bandpass filter resulting from the combination are respectively adjustable by displacement of the short-pass and long-pass filters.

In another variant, the short-pass and long-pass filters are embodied in a disk shape, and are arranged rotatably with respect to one another.

In an embodiment, the short-pass filter and/or the long-pass filter comprises a spectral gradient filter and/or a gradient interference filter and at least one moveable beam stop whereby the spectral stopband of the short-pass filter and/or the one long-pass filter is defined by the relative position of the at least one beam stop to the gradient interference filter and or the spectral gradient filter.

The scanning microscope and the method according to the present invention are suitable in particular for the investigation of samples by multi-photon microscopy using second-harmonic generation, since the low detected light power level can be used in largely loss-free fashion. A pulsed light source, preferably a pulsed laser that can be embodied, for example, as a titanium/sapphire laser, is preferably provided for generating the illuminating light.

In an embodiment, the light path of the detected light encompasses several detection channels, and a bandpass filter can be provided in each of the detection channels.

In a particular variant, the detected light that does not pass through the bandpass filter is reflected into other detection channels. In this embodiment, the bandpass filter causes splitting of the detected light into different detection channels. It is thus conceivable, for example, for light from a two-photon excitation process also to be simultaneously detectable in addition to the detected light that contains light from a second-harmonic process.

In an embodiment, the scanning microscope is configured as a confocal scanning microscope.

### BRIEF DESCRIPTION OF THE DRAWINGS

The subject matter of the invention is depicted schematically in the drawings and will be described below with reference to the Figures, identically functioning elements being labeled with the same reference characters. In the drawings:

FIG. 1 shows a portion of a scanning microscope according to the present invention;

FIG. 2 shows a variant of a scanning microscope according to the present invention;

FIG. 3 shows a further variant of a scanning microscope according to the present invention.

FIG. 4 shows a part of a further variant of a scanning microscope according to the present invention.

### DETAILED DESCRIPTION OF THE INVENTION

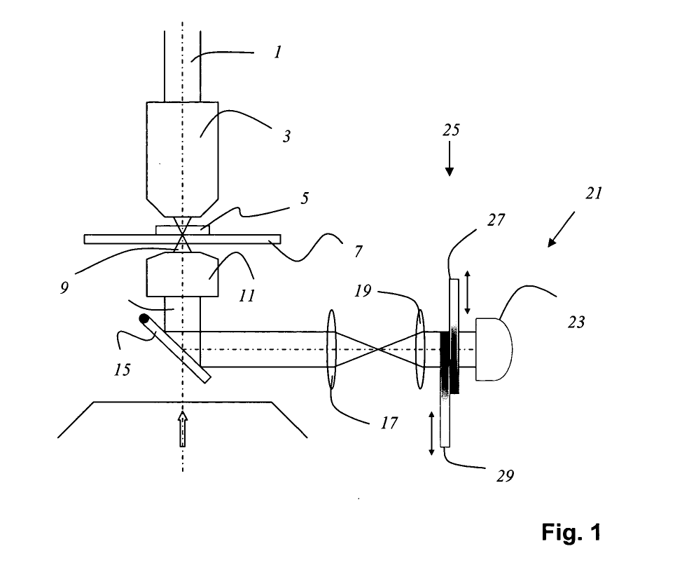

FIG. 1 shows the portion of a scanning microscope that is essential to the invention. Illuminating light 1 coming from a light source is focused by an objective 3 onto a sample 5 that is positioned on a coverslip 7. Detected light 9 proceeding from the sample is collimated by a condenser 11 into a detected light beam 13 that is directed by mirror 15, through optical systems 17 and 19, to detector 21 that is embodied as photomultiplier 23. A bandpass filter 25 that contains a short-pass filter 27 and a long-pass filter 29 is located in the light path of detected light 13. Short-pass filter 27 and long-pass filter 29 are embodied as spectral gradient filters that are displaceable with respect to one another transversely to the propagation direction of detected light beam 13 in order to adjust the lower and upper limits of the bandpass filter.

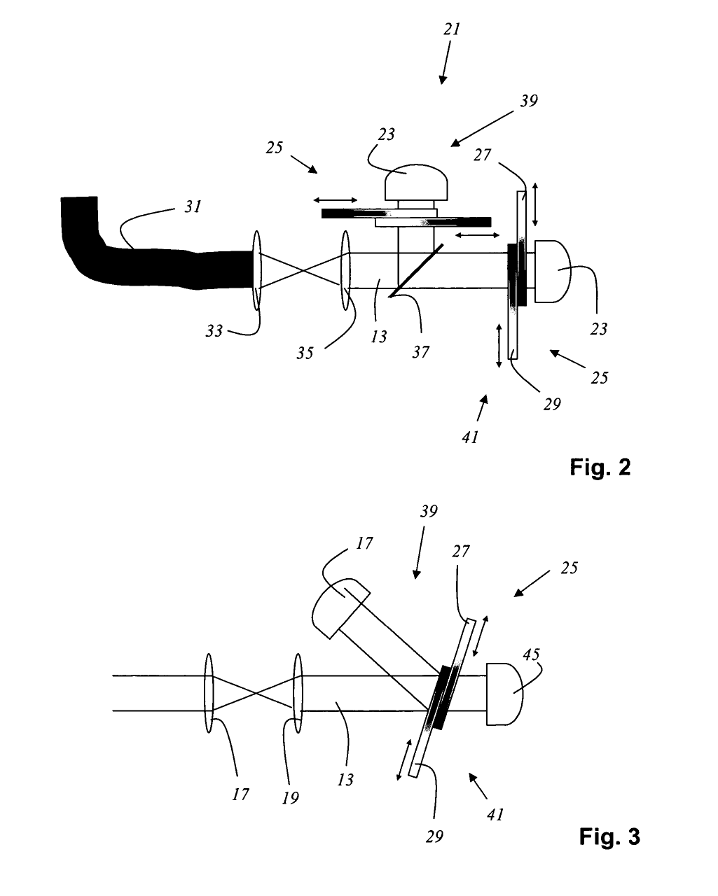

FIG. 2 shows a variant in which the detected light proceeding from the sample has been coupled into a light-guiding fiber 31 for transport to non-descan detector 21. Outcoupling optical systems 33, 35 are provided for coupling detected light 9 out of light-guiding fiber 31. The outcoupled collimated detected light beam 13 is spectrally split by a dichroic beam splitter into two detection channels 39, 41. Each of detection channels 39, 41 contains a photomultiplier 23, in front of each of which is positioned a bandpass filter 25. A spectral preselection is performed by means of dichroic beam splitter 37, whereas spectral fine adjustment is made possible by bandpass filters 25.

FIG. 3 shows a variant in which detected light beam 13 is split by bandpass filter 25 itself into a first detection channel 39 and a second detection channel 41. The portion of detected light beam 13 that does not pass through long-pass filter 29 is reflected to first detector 43, whereas the component that passes through bandpass filter 25 strikes second detector 45.

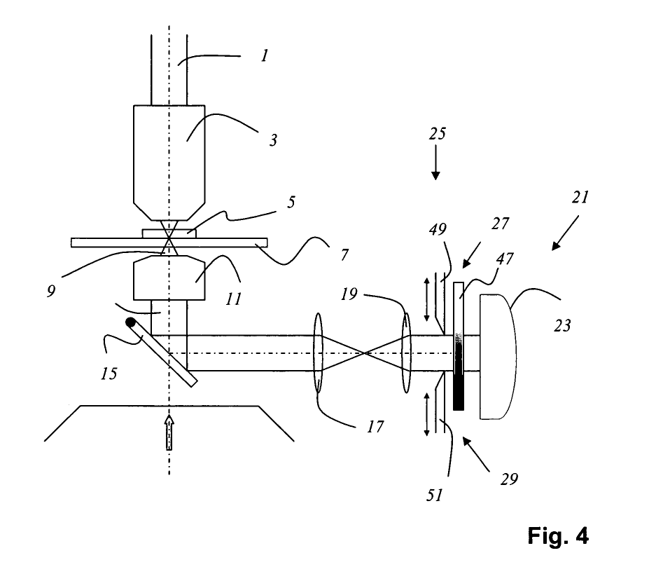

FIG. 4 shows a part of a further variant of a scanning microscope according to the present invention which comprises a gradient interference filter 47. The gradient interference filter 47 acts together with a first beam stop 49 as a short-pass filter 27. The gradient interference filter 47 acts together with a second beam stop 51 as a long-pass filter 29. The spectral stopband of the short-pass filter 27 and of the long-pass filter 29 can be varied by displacing the first beam stop 49 or respectively the second beam stop 51 relative to the gradient interference filter 47 as indicated by the arrows.

The invention has been described with reference to a particular exemplary embodiment. It is self-evident, however, that changes and modifications can be made without thereby leaving the range of protection of the claims below.

1. A scanning microscope comprising: a non-descan detector for detecting the detected light proceeding from a sample, a bandpass filter, which comprises a combination of at least one short-pass filter and at least one long-pass filter and which is arranged in the light path of the detected light.

2. The scanning microscope as defined in claim 1, wherein the short-pass filter and/or the long-pass filter comprises a spectral gradient filter and/or of a dielectric filter and/or of a gradient interference filter.

3. The scanning microscope as defined in claim 1, wherein the short-pass filter and/or the long-pass filter comprises a spectral gradient filter and/or a gradient interference filter and at least one moveable beam stop whereby the spectral stopband of the short-pass filter and/or the one long-pass filter is defined by the relative position of the at least one beam stop to the gradient interference filter and or the spectral gradient filter.

4. The scanning microscope as defined in claim 1, wherein the short-pass filter and/or the long-pass filter are rotatable and/or displaceable relative to one another.

5. The scanning microscope as defined in claim 1, wherein generation of the detected light in the sample encompasses a second-harmonic generation (SHG) process and/or a multi-photon process.

6. The scanning microscope as defined in claim 5, further comprising a pulsed light source, in particular a pulsed laser, for generating the illuminating light.

7. The scanning microscope as defined in claim 1, wherein the light path of the detected light encompasses several detection channels.

8. The scanning microscope as defined in claim 1, wherein the scanning microscope is a confocal scanning microscope.

9. A method for scanning microscopy on a sample, comprising the steps of:
ascertaining an illuminating light frequency at which detected light having the frequency of a harmonic of the illuminating light frequency can be generated in the sample;
illuminating the sample with illuminating light of the ascertained illuminating light frequency;
blocking out from the detected light proceeding from the sample those light components that have the frequency of the illuminating light and/or the frequency of autofluorescence light, using a bandpass filter that comprises a combination of a short-pass and at least one long-pass filter and is arranged in the light path of the detected light; and
detecting the filtered detected light using a non-descan detector.

10. The method as defined in claim 9, wherein the short-pass filter and/or the long-pass filter comprises a spectral gradient filter and/or of a dielectric filter and/or of a gradient interference filter.

11. The method as defined in claim 9, wherein the short-pass filter and/or the long-pass filter comprises a spectral gradient filter and/or a gradient interference filter and at least one moveable beam stop whereby the spectral stopband of the short-pass filter and/or the one long-pass filter is defined by the relative position of the at least one beam stop to the gradient interference filter and or the spectral gradient filter.

12. The method as defined in claim 9, wherein the short-pass filter and/or the long-pass filter are rotatable and/or displaceable relative to one another.

13. The method as defined in claim 9, wherein generation of the detected light in the sample encompasses a second-harmonic generation (SHG) process and/or a multi-photon process.

14. The method as defined in claim 13, further comprising a pulsed light source, in particular a pulsed laser, for generating the illuminating light.

15. The method as defined in claim 9, wherein the light path of the detected light encompasses several detection channels.

16. The method as defined in claim 15, wherein bandpass filters are provided in several detection channels.

17. The method as defined in claim 15, wherein the bandpass filter causes splitting of the detection channels.

18. The method as defined in claim 9, wherein a confocal scanning microscope is used to carry it out.
